(19) United States
(12) Patent Application Publication
(10) Pub. No.: US 2010/0202385 A1
(43) Pub. Date: Aug. 12, 2010

(54) SYSTEM, METHOD AND APPARATUS FOR ROUTE-OPTIMIZED COMMUNICATION FOR A MOBILE NODE NESTED IN A MOBILE NETWORK

(76) Inventors: Jun Hirano, Kanagawa (JP); Mohana Dhamayanthi Jeyatharan, Singapore (SG); Chan Wah Ng, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(21) Appl. No.: 12/679,664

(22) PCT Filed: Sep. 24, 2008
(86) PCT No.: PCT/JP2008/002630

§ 371 Date: Mar. 23, 2010

(30) Foreign Application Priority Data
Sep. 28, 2007 (JP) 2007-254765

(51) Int. Cl. H04W 4/00

(52) U.S. Cl. 370/329

(57) ABSTRACT

To overcome the routing sub-optimality problem arising in the heterogeneous protocol scenario where end-to-end route optimization protocol such as the Access Router Option protocol and Hierarchical Mobility Management protocol are implemented in the mobile hosts and mobile routers, this invention presents three methods. The first method is such that when visiting mobile node or mobile router wants to perform access router option based route optimization with some node, it will use its local care-of address as its care-of address. The second method is such that when visiting mobile node or mobile router decides to use hierarchical mobility management with some node, it will use regional care-of address as its care-of address. The third method is such that when there is legacy mobility anchor point in architecture, mobile router does not send the mobility anchor point option in its router advertisement.

### TECHNICAL FIELD

This invention relates to the field of telecommunications in a packet-switched data communications network. More particularly, it concerns providing an optimized route to a mobile node having an end-to-end route optimization protocol and hierarchical mobility management protocol implemented and operates in a system where there is a single mobility anchor point.

### BACKGROUND ART

Many devices today communicate with each other using the Internet Protocol version 6 (IPv6). In order to provide mobility support to mobile devices, the Internet Engineering Task Force (IETF) has developed the “Mobility Support in IPv6 (MIPv6)” [Non Patent Citation 1]. Mobility support is done in [Non Patent Citation 1] with an introduction of an entity at the home network known as a home agent (HA). Mobile nodes (MNs) register their care-of addresses that they obtain in foreign links with the home agents using messages known as Binding Updates (BU). This allows the home agent to create a binding between the home address, which is the long-term address obtained in the home link, and care-of address of the mobile node. The home agent is responsible to intercept messages that are addressed to the mobile node's home address (HoA), and forward the packet to the mobile node's care-of address using packet encapsulation (i.e. putting one packet as the payload of a new packet, also known as packet tunneling). In addition, MIPv6 also specifies a route optimization (RO) method when communicating with a correspondent node (CN). This RO mechanism allows the MN to perform a validated registration of its care-of address at CN so that MN and CN can communicate with each other using MN's care-of address, without having to go through the home agent. CN obtains a validated registration of MN's care-of address by means of Return Routability (RR) test that is initiated by MN. This Return Routability test provides a proof to the CN that the care-of address of MN is collocated with MN's home address. This RO mechanism is an optional mechanism and its benefits are obtained only when the CN has some functionality to support RO mechanism.

One problem with MIPv6 is that for a single change in network attachment, the MN needs to update one or more of its home agents and one or more of its correspondent nodes. This increases the signaling load injected into the network for fast moving MN. Moreover, the average hand-off establishment time with CN per change in network attachment is high as every single change in network attachment involves transmission of RR and BU messages. Thus, during a session associated with a flow or connection, considerable amount of time is allocated to hand-off establishment, which results in jitters and packet losses. Such jitters are detrimental for applications such as voice over IP (VoIP), multimedia and video streaming and packet losses are detrimental for flows that carry critical text information. Furthermore, packet losses decreases transmission control protocol (TCP) throughput when TCP is used for information critical data applications.

To address such issues of MIPv6, IETF has standardized a protocol called the hierarchical mobility management protocol version 6 (HMIPv6) disclosed in [Non Patent Citation 2]. HMIPv6 uses two types of care-of addresses and a new node called the Mobility Anchor Point (MAP). The basic principle is that the MN derives two care-of addresses at a new network it is attached to. One of the care-of addresses is called the Local care-of address (LCoA) which is the address obtained from the network MN is directly attached to. The other address is called the Regional care-of address (RCoA) and it is derived from the MAP's network prefix. The RCoA is the address the MN will use as the care-of address when communicating with CN and HA. Since MAP is preferably a fixed router placed higher up in the routing hierarchy, this RCoA does not change often. As long as the roaming MN is inside the network segment where the MAP info can be obtained, Regional care-of address does not change. In this protocol, for every change in network attachment, the hand-off establishment procedure is mostly with the MAP where the LCoA is registered. Only when the MN moves out of the MAP and hence the RCoA is changed, will there be simultaneous updates or hand-off establishments to MAP, CNs and HAs. Thus, on average, signaling load into network per change in network attachment is much less when compared to MIPv6. Furthermore, for every change in network attachment, the hand-off establishment time is less on average. This is because, majority of the time, hand-off is only associated with a simple LCoA registration at MAP which is placed at close proximity to the roaming MN. Thus the complexities such as jitters and packet losses discussed previously are much less here. This protocol is an accepted standard for nodes that want power saving for its flows and for nodes that carry flows that require stringent QoS parameters.

With the ever-increasing proliferation of wireless devices, it is foreseeable that a new class of mobility technology will emerge: network mobility, or NEMO, where a whole network of nodes changes its point of attachment in entirety. The IETF has developed a solution for basic network mobility support disclosed in [Non Patent Citation 3]. Here, it is specified that the mobile router (MR) when sending BU to home agent, will specify the network prefix, which the nodes in the mobile network are using. These are specified using special options known as Network Prefix Options to be inserted into the BU. These allow the home-agent to build a prefix-based routing table so that the home-agent will tunnel any packets sent to destinations with these prefixes to the care-of address of the mobile router.

When a MN is deeply nested in a NEMO, two types of problems arise. The first type of problems includes overhead of multiple encapsulations and suboptimal routing for data packets. This is due to nested tunneling for the nested NEMO scenario. Multiple encapsulations results in delay of data packet due to the increase in packet size and may also further lead to packet fragmentation. Packet fragmentation may further result in data packet loss. Sub-optimal routing also leads to data packet delay, increase in network load and burdening the HAs with higher processing load.

The second type of problems includes the massive delay for layer three hand-off establishments for the deeply nested MN and the high signaling load injected into the network due to signaling overhead of RR and BU stream. This arises because when MN is deeply nested and if there is change in network attachment and hence the care-of address obtained has to be updated to the CNs or HAs, there will be a massive delay in such registration due to the packets involved in hand-off registration being subjected to multiple encapsulations. As discussed previously, this increase in hand-off delay time will contribute significantly to the overall session or connection time of a flow carried by a fast moving MN, which results in jitters and packet losses. Furthermore, excessive hand-off establishment signaling by a MN during a given time affects other flows carried in the network as well.

To solve the first type of problems, there have been various proposals to what is known as a nested tunnel optimization in the relevant field of art. Particularly, [Non Patent Citation 4] discloses a solution known as the Access Router Option (ARO). This new option, called the Access Router Option, is used by the sender (i.e. mobile router or mobile host) to inform the recipient (e.g. home agent or correspondent node) the primary global address of the access router the sender is attached to. After sending the binding update message with the access router option, the mobile node can then insert a special signal called the “direct-forwarding-request” signal to the data packet it sends out. This signal will cause upstream mobile access router to send binding updates of its own to the destination address. This process is repeated until the topmost mobile access router is reached. With all upstream mobile access routers sending binding updates to the destination, the destination can build a chain of mobile access routers the mobile node is attached to. This can be used to construct the extended Type 2 Routing Header (RH2), so that when the destination node wants to send a packet back to the mobile node, it can embed the packet with the routing header, and the packet will be routed directly to the mobile node via the chain of mobile access routers. This method is considered as an adequate method to provide end-to-end route optimization without trading off the security.

To solve the second type of problems and to partially solve the first type of problems,

[Non Patent Citation 5] reveals a scheme where the design of the scheme tackles issues such as nested tunneling and Layer three (L3) hand-off establishment delay. This scheme attempts to improve hand-off efficiency and signaling overhead and provide reasonable end-to-end route optimization for a nested MN in a MAP environment. In this scheme, every MN (which is considered as a mobile host in this document) behaves as specified in HMIPv6. For every change in local network attachment, the MN will update its LCoA at the MAP, and for every change in the RCoA or the MAP domain, the MN will update its CNs and HAs of the new RCoA. In this scheme, it is also assumed that the MR will operate as specified in the HMIPv6 protocol for the MN but will have slight modifications. The MR when it operates in the router mode will advertise the MAP option in its router advertisement (RA) to extend the MAP services to the MNs that are attached to it. Furthermore, in order to help the MAP trace the optimum path to reach a MN LCoA, the MRs will do a prefix scoped binding update (PSBU) at the MAP instead of the pure HMIPv6 type of registration. Suppose the MN is deeply nested behind some number of MRs, the binding cache at the MAP will have MN's LCoA, RCoA as well as the upstream MRs LCoAs, RCoAs and prefix of the MRs. It should be well-known to one skilled in the art how the MAP can use this prefix to locate all the LCoA associated with the MN's upstream MRs. Such tracing is possible because the MN's or MR's LCoA is derived from its access router's prefix.

When a data packet arrives at the MAP for a RCoA associated with the MN, MAP will first locate this RCoA. Then the MAP will find the corresponding LCoA associated with this RCoA in the binding cache entry (BCE). Following that the MAP will search for the prefix that matches this LCoA of MN. By doing this, MAP can find the location parameters of the direct mobile access router of MN and repeat such process until all the upstream MRs LCoAs can be obtained. Once such recursive tracing is done at the MAP, it will tunnel the data packet to the MN by inserting a routing header in the tunnel consisting of the all-upstream MRs LCoAs. When MN sends a packet to the CN, as in HMIPv6, MN will first encapsulate the packet in a tunnel to the MAP. All the upstream MRs of MN, since it has a binding at the MAP, will further encapsulate the packet in separate tunnels to the MAP. The final effect of this scheme is that for incoming data packets, there will be a single tunnel from MAP with extended routing header. For outgoing data packet there will be multiple encapsulations from MN/MR to MAP in the wireless domain. It is important to understand that this protocol mainly attempts to improve hand-off and signaling for a MN deeply nested in a NEMO. When comparing this scheme to the ARO scheme as disclosed in [Non Patent Citation 4], it is important to appreciate that the ARO scheme provides better end-to-end RO. This is because in ARO, there is no tunnel in the wireless domain in the reverse direction, whereas there are multiple tunnels in the wireless domain in [Non Patent Citation 5]. In addition, for ARO, there is no tunnel in the forward direction.

From the above discussions it can be foreseen that in the future, different types of protocols may need to be implemented in the system in order to achieve the objectives of data flows, end terminals and networks. As far as data flows are concerned, the main objective will be to reduce delay, jitters and packet loss. The main objective of the network perceived QoS is to reduce the network load or more correctly the signaling load into the network. The MN's objective is to save power. Hence in order to combine all these objectives as a single goal, it is very likely that multiple protocols may need to be implemented in the system. A future MN may need to support different types of flows having different QoS needs. For example, the MN may carry some flows that require strict end-to-end RO and also some flows that are not strict about end-to-end RO. For flows that are not too strict about end-to-end RO the MN may need to consider improving signaling load injected into network and save power by reducing frequent binding updates. Thus, it is foreseeable that in the future different type of protocols needs to be implemented in a MN, MR, some key routers and CN.

In the future there may be a scenario where both ARO and HMIPv6 protocols are implemented in a single MN/MR and these nodes are roaming in a global communications network where they encounter different type of MAPs. The above said MAP can be legacy HMIPv6 type of MAP as disclosed in [Non Patent Citation 2] or can be a MAP with some RO functionality as explained in [Patent Citation 3]. In such a scenario, we next analyze the signaling and data packet routing in the system, when the MNs and MRs operate according to standard mechanisms associated with the ARO and HMIPv6 protocols implemented in them. FIG. 1 further describes this scenario.

FIG. 1 shows a system where there is a single mobility anchor point MAP 40 in the network architecture. This can be a legacy HMIPv6 type of MAP, a MAP with a RO functionality such as an ARO enabled MAP, a MAP which delegates prefixes and process prefix scoped binding update or a MAP which does not delegate prefixes but process PSBU with appropriate validation. In this scenario, routing sub-optimality problems and other problems are analyzed for a legacy MAP and a MAP with some RO functionality, without focusing on the details of the RO processing functionality associated with the MAP.

Visiting Mobile Node (VMN) VMN 10 is situated in NEMO 101 and attached to MR 20 via a wireless link, MR 20 is situated in NEMO 102 and attached to MR 21 via a wireless link, MR 21 is situated in wireless access network 103 and attached to AR 30 via a wireless link, AR 30 is situated in fixed access network 104 and attached to MAP 40 via a wired link and the MAP 40 is attached to the global communications network 100 (Internet) via a fixed access network using a wired link. The home agents of MR 20 and MR 21 are HA 51 and HA 50 respectively. The home agent of VMN 10 is not explicitly revealed in the figure. VMN 10 is having a data communication session with CN 60, which is attached to the global communications network 100.

To highlight the problem in this scenario we first consider a legacy HMIPv6 type MAP. In such a scenario, VMN 10 and MR 20 will obtain both ARO and MAP options in the router advertisements they receive. MR 21 will only obtain the MAP option. When such heterogeneous processing options are available for the VMNs and MRs, they can choose whatever option or combination of options. The problem is highlighted in a specific instance that occurs in this scenario. Nevertheless, similar problems occur even in other instances of this scenario and one skilled in the art can easily understand it. It is assumed that VMN 10 process both ARO and MAP options, MR 20 process only the ARO option and the MR 21 process only the MAP option. In such an instance of this scenario, MR 21 will process MAP option, derive RCoA and LCoA and make local binding registration at MAP 40. This is further illustrated by the MAP 40 binding cache (BC) 71 in FIG. 1. Since, initially, a legacy MAP is considered to highlight the problem, the third column in the BC 71 will be empty because there is no RO tracing parameter acceptability or usage mechanism available in the MAP. MR 20, since it only process ARO option will not make any registrations at the MAP 40. VMN 10, having processed both ARO and MAP options will configure RCoA and LCoA. VMN 10 will now attempt to do local registration at the MAP using the ARO option. The value in the above said ARO option may be a value that can be useful to optimally trace the relevant LCoAs associated with a RCoA. Since the MAP is legacy type, it will not understand the ARO option and hence ignore the option and will make a normal HMIPv6 registration in its BC 71. This said registration created at MAP 40 due to VMN 10 is shown in the second row of BC 71. After making appropriate registration at MAP 40, VMN 10 will next register at its home agent and may perform ARO mechanism with CN 60 to achieve route optimization. The VMN 10 possibly performs ARO with CN because it process MAP option first and then ARO option. Moreover, since VMN 10 processes the MAP option first and then the ARO option, it will use the RCoA as its CoA when performing ARO with CN 60. After such ARO binding at CN 60, the first row of entry as shown in BC 70 will appear. BC 70 is the binding cache at CN 60. CN 60 will send an Acknowledgement (ACK), which will incorporate the HoA of MR 20 in RH2. After receiving the ACK, MR 20 will know that CN 60 does not have binding for its HoA and will start ARO mechanism at CN 60. Following a successful ARO mechanism at CN 60, the second row of entry with MR 20 parameters will appear in BC 70. It is important to understand, since MR 20 only processes the ARO option, it will only use its LCoA as its CoA when communicating with CN 60. Following that, again, CN 60 will send an ACK with HoA of MR 21 in RH2. Once MR 21 receives this packet, MR 21 will use its RCoA to do the ARO registration at CN 60. MR 21 will use RCoA to do ARO registration because although it has configured a RCoA by processing the MAP option, it will process the ACK which was sent to MR 20 using the ARO stack. This registration is shown by the third entry in BC 70. When CN 60 sends a data packet 80 to VMN 10 using the BC 70, the data packet will encounter severe route sub-optimality problem.

Data packet 80 from CN 60 has the destination address as MR 21 RCoA. The routing header 2 will have the MR 20 LCoA, VMN 10 RCoA and VMN 10 HoA. This packet 80 will be first sent via the path 110. The packet will be first intercepted by MAP 40. Since MAP 40 has registration for RCoA of MR 21, it will encapsulate this packet in a tunnel to LCoA of MR 21. The tunnel is not explicitly revealed in the figure. The tunneled packet will reach MR 21 again via the path 110. After decapsulation at MR 21, MR 21 will change the destination address to LCoA of MR 20. MR 21 obtains this next destination address from the RH2 attached in packet 80. Thus the packet reaches MR 20 via 110. At MR 20, again the destination will be changed to RCoA of VMN 10. Since MR 20 does not have any registrations to reach RCoA of VMN 10 optimally, the packet will be tunneled via MR 20's home agent HA 51. This packet travels via path 111. Again at MR 21, it will be further tunneled via MAP 40 and MR 21's home agent HA 50. This multi-encapsulated packet will get decapsulated at MAP 40, again get decapsulated at HA 50 and then finally get decapsulated at HA 51 and finally get intercepted at MAP 40. It is important to note that the path 111 explains all these procedures. To reduce the complexity associated with the FIG. 1, this was not explicitly drawn in this figure. Nevertheless, to one skilled in the art these routing processes are quite straightforward. Once, MAP 40 gets this packet 80, it will note that it does have a registration to RCoA of VMN 10. Thus, MAP 40 will tunnel the packet to LCoA of VMN 10. This packet will travel via 112 to home agent of MR 20, which is HA 51. There the packet 80 will be further encapsulated to LCoA of MR 20. This packet will now travel via the path 113 and reach HA 50, which is the home agent of MR 21. Here the packet will be further encapsulated to RCoA of MR 21. Thus the multi-encapsulated packet will now travel via the path 114 and reach MAP 40. Here the packet will be further encapsulated to LCoA of MR 21. The packet will now travel via path 115. At MR 21, the packet will be decapsulated and reach LCoA of MR 20. There will it be again decapsulated and reach LCoA of VMN 10. The packet will be decapsulated again at VMN 10 and VMN 10 will finally consume the packet.
Patent Citation 1: Hirano, J., Ng, C. W., et al., “Method and Apparatus for controlling packet forwarding, and communication node”, WIPO Patent Application Publication WO06129863A1, December 2006.
Patent Citation 2: Hirano, J., Ng, C. W., et al., “Method and Apparatus for controlling packet forwarding”, WIPO Patent Application Publication WO06129858A1, December 2006.
Patent Citation 3: Hirano, J., Ng, C. W., et al., “Method and Apparatus for controlling packet forwarding”, WIPO Patent Application Publication WO06129855A1, December 2006.
Non Patent Citation 1: Johnson, D. B., Perkins, C. E., and Arkko, J., “Mobility Support in IPv6”, Internet Engineering Task Force Request For Comments 3775, June 2004.
Non Patent Citation 2: Soliman, H., et. al., “Hierarchical Mobile IPv6 Mobility Management (HMIPv6)”, Internet Engineering Task Force (IETF) Request For Comments (RFC) 4140, August 2005.
Non Patent Citation 3: Devarapalli, V., et. al., “NEMO Basic Support Protocol”, Internet Engineering Task Force Request For Comments 3963, January 2005.
Non Patent Citation 4: C. Ng and J. Hirano, “Securing Nested Tunnels Optimization with Access Router Option”, IETF Internet Draft: draft-ng-nemo-access-router-option-01.txt, Expired Jan. 10, 2005.
Non Patent Citation 5: Ohnishi, H., Sakitani, K., and Takagi, Y., “HMIP based Route Optimization Method in Mobile Network”, IETF Internet Draft: draft-ohnishi-nemo-ro-hmip-00.txt, April 2003.

### DISCLOSURE OF INVENTION

From the above elaborate explanation of the packet routing procedure, it is evident that the problems are multi-fold. Next the problems are looked in detail. The first noticeable problem is that, since VMN 10 gets both type of options and it does not know that the MAP 40 is legacy type; it is performing ARO binding to the MAP 40, which is not recognized by the MAP 40 (legacy MAP). This wastes bandwidth in the access network of VMN 10 and increases the power consumption of VMN 10. The second problem is that the binding cache 70 at CN 60 creates a ping-pong type of routing problem to and forth between the MAP 40 and the MRs. For example, the final destination of data packet 80 from CN 60 is VMN 10 HoA. Nevertheless, to reach this, the packet has to be sent via heterogeneous type of addresses (MR 21 RCoA, MR 20 LCoA, VMN 10 RCoA). Heterogeneous in this context means, a mixture of RCoA and LCoA entries. Each of these entries has to be reached before reaching the final destination. Thus, when there are heterogeneous type of addresses in a data packet, after reaching the LCoA associated with the RCoA or directly reaching a LCoA, again the next entry in RH may have to be reached, which could be a RCoA. Since the MR's do not have a route to a specific RCoA, this packet has to reach the MAP for proper routing. This is ping-pong routing and is illustrated by paths 110, 111 and 115. Furthermore, the ping-pong routing is severe in such a scenario because, the mobile routers in the default path to VMN 10 can process any type of option and hence the upstream MRs of VMN 10 may not have registrations at the MAP. Thus to reach the MAP 40 from a MR in the MAP domain, the upstream MRs may have to tunnel the packet via its home agent if the MR has only processed the ARO option. All these show the routing sub-optimality directly attached to heterogeneous type of care-of addresses in the data packet 80 from CN 60.

Next, the third problem in this scenario is looked into. This problem is associated with tracing a RCoA optimally at the MAP. Since the MAP 40 is legacy in this particular scenario, it has no RO mechanism to trace the LCoAs required to reach a RCoA optimally. The above said LCoAs comprise the LCoA directly associated with a RCoA and the LCoAs of the upstream MRs that need to be traversed to reach the above said RCoA. To further illustrate this problem one can look at BC 71. For example there is no tracing mechanism available to trace any RCoA. In legacy MAP scenario, it is assumed that the third column is empty. In this case, due to this lack of tracing mechanism to optimally reach a LCoA associated with a RCoA, the packet has to be tunneled and intercepted by home agents in the fixed infra structure. This causes pinball routing in the fixed infrastructure. This is illustrated in FIG. 1 via the path 113. In addition to this routing path sub-optimality, when detail explanation was given to packet path it was evident that the packet had to go through multiple encapsulation procedures. This will increase the average packet size. This contributes to the fourth type of problem. Moreover it was noted that the packet 80 was decapsulated by many routers in the system. This causes processing delays and also causes a processing burden in the routers and thus constitutes the fifth type of problem. All these anomalies show the inefficiency of the system when heterogeneous protocols such as ARO and HMIPv6 are operating and the single MAP is a legacy type.

Next, a scenario is considered where MAP 40 in FIG. 1 has some RO functionality. If the MAP 40 is not legacy (has some RO functionality), and the nodes carry out an ARO registration at the MAP 40, similar problems as described previously are there but the degree of routing sub optimality will be less. The reason for such reduced sub optimality is that, due to RO functionality at the MAP 40, the MAP 40 will be able to trace the LCoAs required to reach some RCoAs optimally provided adequate registrations are there at the MAP. Thus, the infrastructure related pinball routing problem previously explained will be less probabilistically in an RO enabled MAP case. Nevertheless, due to heterogeneous processing options (ARO option, MAP option) available to VMNs and VMN's default mobile access routers, not all registrations will be available at the MAP all the time. This happens when some nodes only process the ARO option. Thus, due to these heterogeneous processing options, the RO enabled MAP may not be able to eliminate the pinball routing problem completely. If the MAP 40 is ARO enabled and the MN performs appropriate MAP registration using appropriate tracing parameter embedded in the ARO option, the ARO option will be accepted. If the MAP 40 has an RO mechanism based on prefix delegation and PSBU, then the MAP 40 will not accept ARO option in the BU coming from VMN/MR. Nevertheless, the prefix given by PSBU is sufficient to perform RO to some extent. In the prefix enabled RO MAP 40 scenario, the ARO option in the BU generated from VMN/MR will be wasted.

From the problem analysis, it can be understood that, when the MAP is legacy in the ARO and HMIPv6 heterogeneous scenario, the MAP is completely unsuitable for nested NEMO route optimization with CN because, it has no RO mechanism available even if VMN and all upstream MRs of VMN process MAP option and register at the MAP. Thus for such a scenario, mechanism for not using the MAP is preferred. When the MAP is RO enabled in the ARO and HMIPv6 heterogeneous scenario, then the MAP can possibly be used in route optimization process as long as the mechanism prevents heterogeneous type of addresses being formed at CN and the mechanism prevents lack of tracing for an intended RCoA at the MAP. Furthermore, even in a RO enabled MAP scenario, the nodes may want to perform full end-to-end ARO type of RO with CN. As shown in the prior art problem analysis, this cannot happen if the nodes process the MAP option first and then the ARO option. If they do process these two options in the above said order, then they end up performing ARO using the RCoA and the full ARO effect cannot be achieved. Thus a mechanism should be there to achieve the full end-to-end ARO type of RO with CN in a MAP domain without involving the MAP.

It is thus an objective of the present invention to overcome or at least substantially ameliorate the afore-mentioned disadvantages and shortcomings of the prior art. Specifically, there are two objectives of the present invention in such an ARO and HMIPv6 heterogeneous scenario when there is a single MAP in the architecture. The first objective is to provide a mechanism to achieve route optimization with CN in an ARO and HMIPv6 heterogeneous scenario where VMNs and MRs both implement the ARO and HMIPv6 protocols and the single MAP in the hierarchy implement some RO functionality or has no RO functionality. The second objective is to be able to achieve route optimization with CN such that ARO type of RO can be achieved if the flows in VMN require excellent RO feature.

In order to achieve the foregoing object, according to the present invention, the following systems, methods and apparatuses are provided.

The present invention provides a system of communications node comprising of VMNs, MRs, MAPs, HAs and CNs where it is considered that the VMNs and MRs have the ARO and HMIPv6 protocol implemented. It is further considered that in this system there is a single MAP in the domain architecture, which has some RO functionality implemented and the HAs have the ARO protocol implemented. In this system it is further assumed that if a first arbitrary node wants to carry out ARO with a second arbitrary node irrespective of the options that has been processed by the above-mentioned first arbitrary node, uses its LCoA as its care-of address.

The present invention provides the method used in the above system where the above said first arbitrary node in the above system is a VMN and it uses its LCoA as its CoA to perform ARO with one or more of its CNs.

The present invention provides the method used in the above system where the above said first arbitrary node in the above system is a MR and it uses its LCoA as its care-of address to perform ARO with VMN's or other MR's CNs.

The present invention provides the method used in the above system where the above said first arbitrary node in the above system is a VMN and it uses its LCoA as its CoA to perform ARO with its one or more HAs.

The present invention provides the method used in the above system where the above said first arbitrary node in the above system is a MR and it uses its LCoA as its CoA to perform ARO with its one or more HAs.

The present invention provides the method used in the above system where the above said arbitrary node in the above system is a MR and it uses its LCoA as its CoA to perform ARO with its one or more CNs.

The present invention provides a system of communications node comprising of VMNs, MRs, MAPs, HAs and CNs where it is considered that the VMNs and MRs have the ARO and HMIPv6 protocol implemented. It is further considered that in this system there is a single MAP in the domain architecture, which has some RO functionality implemented and the HAs have the ARO protocol implemented. In this system it is further assumed that a first arbitrary node wants to perform HMIPv6 with a second arbitrary node, irrespective of the options being processed by the first arbitrary node, uses its RCoA as its care-of address.

The present invention provides the method used in the above system where the above-mentioned first arbitrary node in the above system is a VMN and it uses its RCoA to perform HMIPv6 with one or more of its CNs.

The present invention provides the method used in the above system where the above-mentioned first arbitrary node in the above system is a VMN and it uses its RCoA to perform HMIPv6 with its one or more HAs.

The present invention provides the method used in the above system where the above-mentioned first arbitrary node in the above system is a MR and it uses its RCoA to perform HMIPv6 with one or more of its CNs.

The present invention provides the method used in the above system where the above-mentioned first arbitrary node in the above system is a MR and it uses its RCoA to perform HMIPv6 with its one or more HAs.

The present invention provides the method used in the above system where the above-mentioned first arbitrary node in the above system is a VMN and it performs RO based local registration at MAP where it uses its RCoA as its local home address and its LCoA as its care-of address.

The present invention provides the method used in the above system where the above-mentioned first arbitrary node in the above system is a MR and it performs RO based local registration at MAP where it uses its RCoA as its local home address and its LCoA as its care-of address.

The present invention provides the method used in the above system where if a MR has not processed the MAP option, it will process the MAP option, derive a RCoA and make the RO based local registration at the MAP, if its directly attached VMNs or MRs have already done RO based local registration at that MAP.

The RO registration mentioned in the above method is a method where the RCoA is registered as the home address with some RO parameter at the MAP, so that the LCoAs required to reach the above mentioned RCoA can be done in a very optimized manner.

The present invention provides a system of communications node comprising of VMNs, MRs, MAPs, HAs and CNs where it is considered that the VMNs and MRs have the ARO and HMIPv6 protocol implemented. It is further considered that there is a single MAP in the domain architecture and this MAP is a legacy HMIPv6 type and the HAs have the ARO protocol implemented. In this system it is assumed that MR makes a decision such that, when it knows that the MAP is legacy type, does not send the MAP option in its RA.

The present invention provides a method used in the above system where the MR relies on a new MAP option attached to the RA to know the type of MAP.

The type information as mentioned in the above method can be the type of RO scheme associated with the MAP or information on the legacy MAP.

The present invention provides a method used in the above system where the MR relies on a new option attached to RA to know the type of MAP.

The type information mentioned in the above method could be the type of RO scheme associated with the MAP or information on the legacy MAP.

The present invention provides a method used in the above system where the MR relies on some explicit signaling to know the type of MAP.

The above said explicit signaling in the above method can be ARO type of BU performed at the MAP, where the address in the ARO option could be MR's local care-of address.

The above said explicit signaling in the above method can be the prefix delegation request type of message.

The MR, which makes the decision of not sending the MAP option in the above system, could use its LCoA to carry out ARO with its directly attached VMN's or MR's HAs or CNs.

The MR, which makes the decision of not sending the MAP option in the above system, could use its RCoA to perform ARO with its directly attached VMN's or MR's HAs or CNs.

The present invention provides an apparatus associated with VMN in system as described in the above systems and methods.

The present invention provides an apparatus associated with MR in system as described in the above systems and methods.

The present invention has the advantage of providing a useful mechanism in an ARO and HMIPv6 heterogeneous environment.

### BRIEF DESCRIPTION OF THE DRAWINGS

FIG. 1 shows the network diagram of an ARO and HMIPv6 integration scenario when prior art protocols are deployed and there is single MAP in the architecture.

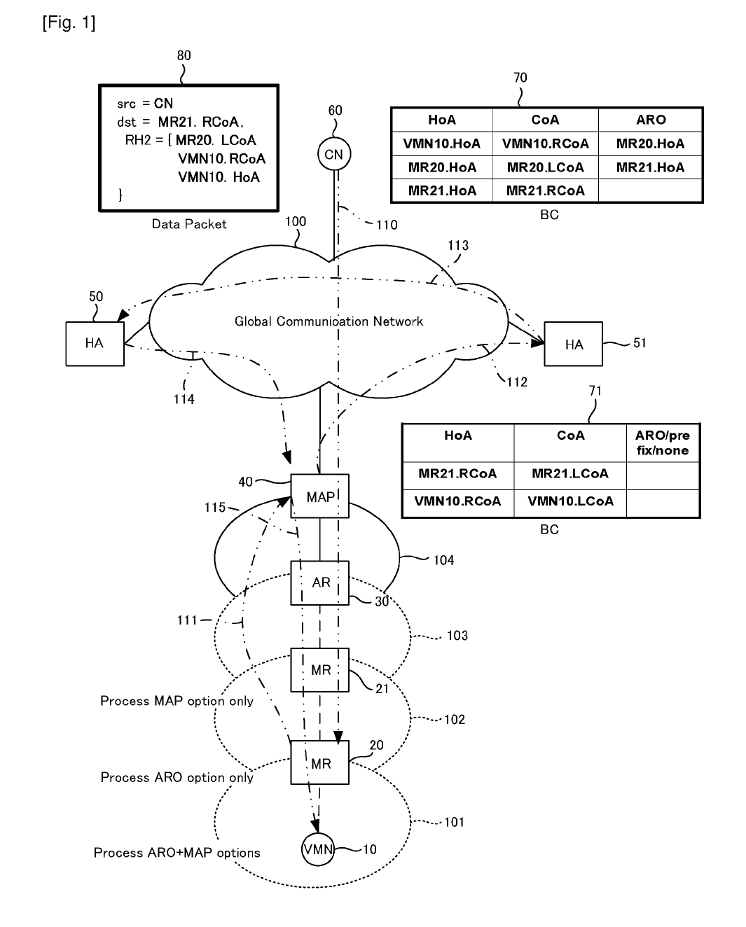

FIG. 2 shows the message sequence chart of the main invention when VMN decides to carry out ARO with CN in a RO enabled MAP scenario according to a preferred embodiment of the present invention.

FIG. 3 shows the message sequence chart of the main invention when VMN decides to carry out HMIPv6 with CN in a RO enabled MAP scenario according to a preferred embodiment of the present invention.

FIG. 4 shows the flow chart associated with the processing in VMN according to a preferred embodiment of the present invention.

FIG. 5 shows the flow chart associated with the processing in MR according to a preferred embodiment of the present invention.

FIG. 6 shows the network diagram, which shows the effect of the solution in a RO enabled MAP scenario according to a preferred embodiment of the present invention.

FIG. 7 shows the network diagram, which shows the effect of the solution in a legacy HMIPv6 MAP scenario according to a preferred embodiment of the present invention.

### BEST MODE FOR CARRYING OUT THE INVENTION

The present invention presents three methods to attain route optimization in an ARO and HMIPv6 integration scenario whereby the VMNs, MRs have the ARO and HMIPv6 protocols implemented, the home agents have the ARO protocols implemented, the CNs have ARO implemented and the single MAP in the architecture can be a legacy type of MAP or a RO enabled MAP. The first method is such that, irrespective of the options being processed (ARO, MAP, ARO and MAP), when VMN/MR wants to perform ARO with its own CN, HA or some other node's CNs, it will use a mechanism such that VMN/MR can experience the full ARO effect for its flows. The second method is such that, again, irrespective of the options being processed (ARO, MAP, ARO and MAP), when VMN/MR wants to perform HMIPv6 with its one or more CNs or VMN/MR directly attached to MR wants to perform HMIPv6 with CN, then, VMN/MR will use the second method such that route optimization with location management efficiency can be obtained. The third method is such that when there is legacy MAP in architecture, MR makes some decision so that VMNs and MRs can enjoy route optimization with CNs or HAs.

In a first preferred embodiment, the above said first method is disclosed. This method aims to achieve the two objectives of the invention: being able to attain RO in a RO enabled MAP environment and for nodes to truly experience the ARO type of end-to-end RO for some flows which have stringent delay requirements. In this method, when VMN/MR wants to perform ARO with its own CN, HA or some other node's CNs, it will use its local care-of address as its care-of address so that VMN/MR can experience the full ARO effect for its flows.

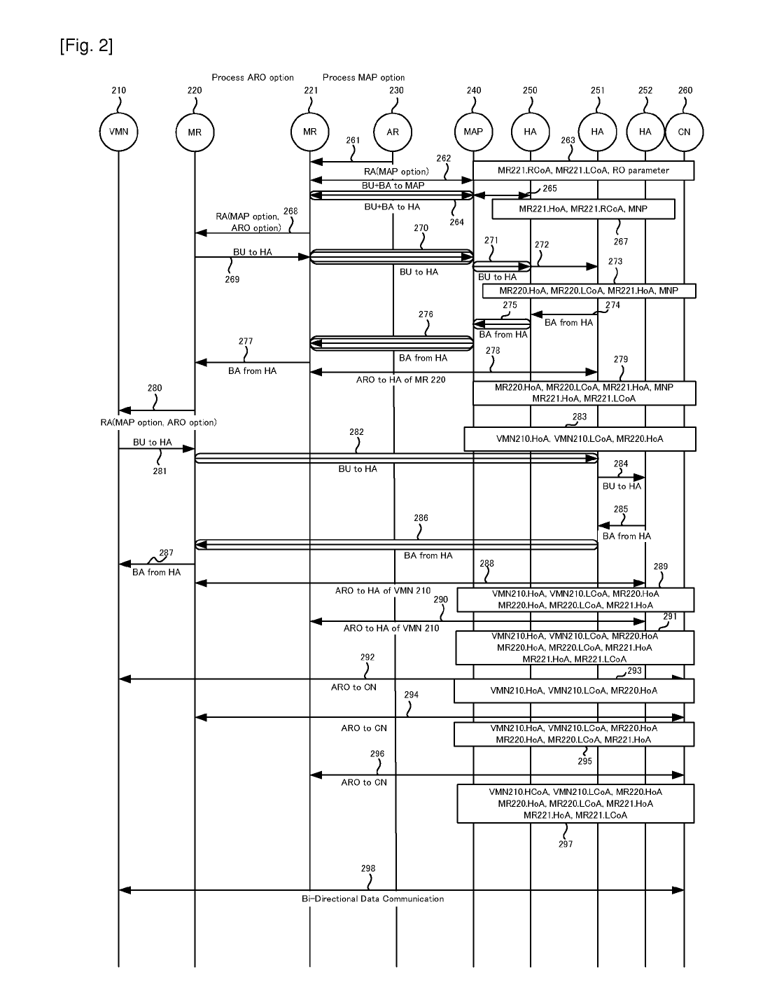

This is further explained by means of FIG. 2. In FIG. 2, VMN 210 is directly attached to MR 220, MR 220 is directly attached to MR 221 and MR 221 is directly attached to AR 230. Basically, it shows a deeply nested scenario. AR 230 is directly attached to MAP 240. The above said MAP 240 is assumed to be RO enabled. HA 250, HA 251 and HA 252 are the home agents of MR 221, MR 220 and VMN 210 respectively. VMN and MRs are assumed to be having the ARO and HMIPv6 protocols implemented in them. VMN 210 is having a data communication session with CN 260 which is ARO enabled.

MR 221 receives RA 261 containing a MAP option from AR 230. In this case, the HMIPv6 stack will be triggered and MR 221 and MAP 240 will engage in local registration. This is shown by message 262. After such local registration, the MAP 240 will have entries as shown in BC 263. Since the MAP 240 is RO enabled, MR 221 will provide some RO parameter in its registration. This RO parameter can be prefix or some ARO address. Following this, MR 221 will register at its own home agent, which is HA 250. This BU and binding acknowledgement (BA) procedure is shown by messages 264 and 265. After such registration, the binding cache at HA 250 will be as shown by 267. Since MR 221 process only the MAP option, the registration at HA 250 will be similar to HMIPv6 type of registration. Nevertheless, the BC 267 will also comprise the mobile network prefix (MNP) of MR 221. This prefix was delegated by HA 250 to MR 221.

Following such registration at HA 250, MR 221 will send a RA 268. This will comprise both ARO and MAP options. This ARO option will have the home address of MR 221 and also it may comprise the RCoA of MR 221. The MAP option will have the MAP 240 address. When MR 220 receives these options, it is assumed in this scenario, it decides to process only the ARO option. In this case, it will configure only one care-of address, which is the LCoA. MR 220 will then send a BU to its home agent, which is HA 251. MR 220 will construct a BU with ARO option. This BU sent by MR 220 is shown by message 269. This message 269 will be tunneled to home agent of MR 221 and the MAP 240. This double encapsulated message is shown by 270. After such tunneling, at MAP 240 the message will be decapsulated and the message 271 with single level of tunneling will be sent to HA 250. At HA 250 the BU message will be further decapsulated and the decapsulated message 272 will be sent to HA 251. After successful registration at HA 251, the BC 273 will have ARO parameter and MNP parameter. It can be seen that MR 220 LCoA will be registered at BC 273. Following successful registration, HA 251 will send a BA to MR 220. This BA will have HoA of MR 221 as the destination address. Thus the BA message sent by HA 251, which is 274, will be first intercepted by HA 250. After that, this message will be tunneled to MR 221 RCoA shown as message 275 in FIG. 2. This tunneled message 275 will be further intercepted by MAP 240. MAP 240 has the LCoA associated with MR 221 RCoA. Thus MAP 240 will put this message in a tunnel and this tunneled message is shown by 276. When message 276 reaches MR 221, it will decapsulate the tunnel twice and change the destination address to MR 220 LCoA and further route the packet. Thus further routed BA message 277 will finally reach MR 220. When MR 221 receives the ACK sent to the HoA of MR 221, it will start the ARO mechanism with HA 251. This is shown by message 278. Details of signaling and routing paths associated with the message 278 are not shown explicitly. Nevertheless, to one skilled in the art these can be deduced easily. After such ARO registration, the binding cache at HA 251 will be as shown in BC 279. In normal operation, when MR 221 has processed the MAP option and has configured a RCoA, it will only reveal its RCoA to CN 260. Nevertheless, in this embodiment, which highlights the first method of the invention, when MR 221 performs ARO with a CN (can be its own or some one else's CN) will use its LCoA as its care-of address. Thus, the BC 279 will have such local care-of address entries.

After such registrations, MR 220 will probably send RA 280. This RA 280 will again have ARO and MAP options. VMN 210 can either process ARO option, MAP option or ARO+MAP options. It was seen in the prior art problem analysis that when VMN process both MAP option and ARO option it ends up performing RCoA based ARO with its CN. The core point about the method outlined in this embodiment is that it prevents VMN to use RCoA based ARO with CN.

In the event that such a method is used by VMN 210, VMN 210 will first register with its home agent if it has not done so. It is important to appreciate that VMN 210 can still register with the MAP 240 and use RCoA for some flows. Nevertheless, if VMN 210 wants to perform ARO with a CN then this is the method it has to follow.

The BU message to HA 252 is shown by 281. This message will be tunneled via the home agent of MR 220, which is HA 251. Since MR 220 has performed ARO with HA 251, MR 220 will insert the NEMO-FWD option in this message. When MR 221 processes this tunneled message 282, since it has an ARO binding with HA 251, it will change the source address to its LCoA and further route the message 282. This BU message 282 will be decapsulated at HA 251 and the decapsulated BU message 284 will eventually reach HA 252. The binding cache at HA 252 is given by BC 283.

It is important to appreciate if VMN 210 has previously processed only MAP option and has done appropriate registration at HA 252 then it need not carry out such registration again. In this embodiment it is assumed that no registration is made and hence it decides to perform ARO registration using its LCoA. After such registration, HA 252 will send an ACK to MR 220 HoA. This message is shown as 285. This will reach HA 251 and will be tunneled to LCoA of MR 220. The destination address of this tunneled message 286 will be LCoA of MR 221. MR 221 will receive BA 286 and change destination address to LCoA of MR 220 and further route the BA message. This message 286 will be sent to MR 220 and will be fully decapsulated at MR 220. Finally, the decapsulated message 287 will reach VMN 210. After this, MR 220 will engage in ARO with HA 252. This ARO signaling message is shown by 288 and the BC created at HA 252 is shown by 289. Again one can see, since MR 220 process only ARO option it will simply register its LCoA when it performs ARO with HA 252. Following that, MR 221 will carry out ARO with HA 252 and this is shown by message 290. The binding cache at HA 252 is shown by BC 291. Again, as discussed previously, although MR 221 has only processed the MAP option, when its ARO stack is triggered it will use the LCoA when it performs ARO registration at CN (HA 252). It can be appreciated by one skilled in the art that the BC 291 has all the relevant parameters to trace VMN 210 optimally from HA 252.

VMN 210 will now perform ARO with CN 260. This is shown by the message 292. After this, the binding cache at CN 260 is given by BC 293. One can see that the VMN 210 only uses the LCoA to perform ARO with CN irrespective of whether it has processed a RCoA. VMN 210 could possibly use RCoA to communicate with some other CN. This will be explained in greater detail in the next embodiment. Following successful ARO registration between VMN 210 and CN 260, MR 220 will perform ARO with CN 260. MR 220 will again use only its LCoA to perform ARO with CN 260 and this ARO registration is shown by message 294. This ARO at MR 220 may have been triggered due to NEMO-FWD option in the data packet of VMN 210 or the ACK sent from CN 260. After MR 220 performs ARO at CN 260, the binding cache at CN 260 will be BC 295. After this, MR 221 will engage in ARO with CN 260 and this ARO establishment message is given by 296. After successful registration, the binding cache at CN 260 will be BC 297. From BC 297 one can see that CN 260 can trace all the LCoAs required to reach VMN 210 optimally. Following this, VMN 210 and CN 260 can engage in bi-directional data communication as shown by 298. This communication path and structure will be of pure ARO type. Thus, even though VMN/MR process multiple types of options, when it performs ARO with CN, it uses LCoA and hence achieves a full RO and eliminates the routing sub-optimality as described in the prior art analysis. Moreover, by this mechanism, any VMN can choose to perform full ARO to some flows that have such critical delay requirements even if it has only processed MAP option previously. To do this, the layer three needs to have some requirements sent from the application regarding the flows. This can be done in many ways, such as adding some flags in the socket implementation.

In another preferred embodiment of the present invention the second method of the invention is described. The second method deals with a situation where VMN/MR may process both ARO and MAP options. Nevertheless, if it wants to carry out HMIPv6 with a CN for location management efficiency related RO, then, it will use RCoA as its CoA and will carry out normal HMIPv6 registration with the MAP and use its RCoA when registering a binding with CN. The type of RO related local BU to the MAP depends on the RO functionality of the MAP. In the prior art scenario, when VMN process both options, VMN will end up performing ARO with CN using RCoA, which causes all the problems discussed previously. The second method also deals with the case where, although an MR process only an ARO option, but if a VMN or MR directly attached to it has processed a MAP option and is attached to a MAP, this MR will process the MAP option and will make appropriate MAP registration. The aim of this second method is to have RCoA based RO for flows even when VMNs and MRs process both ARO and MAP options. It can be understood by one skilled in the art that RCoA based RO is useful for flows that require less jitter, for VMNs that are power-limited and when there is a preference to reduce the network signaling load.

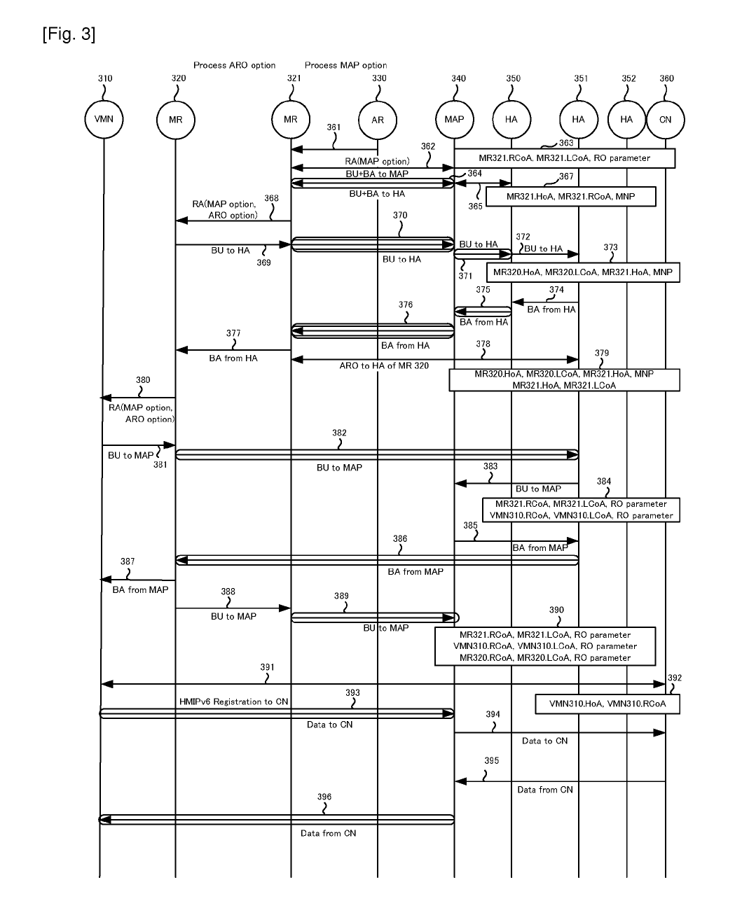

This method can be further explained by going through the signaling and data packet routing process as described in FIG. 3. VMN 310 is directly attached to MR 320, MR 320 is directly attached to MR 321, MR 321 is directly attached to AR 330 and AR 330 is directly attached to MAP 340. It is further assumed that MAP 340 is RO enabled. Moreover, HA 350, HA 351 and HA 352 are the home agents of MR 321, MR 320 and VMN 310 respectively. It is assumed that VMN 310 is having a data communication session with CN 360 which is ARO enabled.

MR 321 receives RA 361 and receives the MAP option. Following which, MR 321 will perform a local BU at MAP 340. This is given by message 362. Following which, MR 321 will carry out BU registration to its home agent HA 350. These registrations are shown by messages 364 and 365 in FIG. 3. HA 350 will then have a binding cache as given by BC 367. After performing appropriate registrations, MR 321 will send a RA 368 with both ARO and MAP options. In this scenario, it is further assumed that MR 320 will process only the ARO option. In such a case it will use the LCoA and send a BU message 369 with the ARO option to its home agent HA 351. This message will be doubly encapsulated by MR 321 as shown by message 370. Again, MAP 340 will decapsulate this message and the decapsulated message 371 will reach HA 350. HA 350 will further decapsulate the message and route the message to HA 351. This BU message routed via HA 350 is given by 372.

Once HA 351 gets this registration, the binding cache will look like the one shown by BC 373. It can be noted that the registration will have the LCoA of MR 320 as the care-of address. As described in the previous embodiment, the ACK from HA 351 will go through different paths and tunneling. This is shown by messages 374, 375, 376 and 377 in FIG. 3. When MR 321 receives an ACK from HA 351 where the ACK is destined to MR 321 HoA, it will perform ARO with HA 351. This is shown by message 378. It is assumed that MR 321 performs ARO BU registration according to the inventive method disclosed in the previous embodiment. That is, when MR 321 performs ARO with the home agent of MR 320, it will use LCoA to perform ARO. After such ARO registration, the binding cache at HA 351 will be given by BC 379. It can be seen that entries there are sufficient to reach MR 320 optimally. After such registration, MR 320 will send a RA 380 consisting of both options. Suppose VMN 310 decides to perform RCoA based RO with its CN 360, then it will only use the RCoA and activate the HMIPv6 stack. In this case, again it needs to register appropriate local BU with some RO parameter at MAP 340. This local BU message is shown by 381. Since MR 320 has no binding with MAP 340, MR 320 will possibly tunnel the packet via its home agent, which is HA 351. This is shown as tunneled message 382 in FIG. 3.

When MR 320 receives this message 382 with a NEMO-FWD option, since it has carried out an ARO binding with HA 351, it will merely change the source address to its LCoA and further route the packet. The local registration message will get decapsulated at HA 351 and will reach MAP 340. This decapsulated message is given by 383. When the MAP 340 accepts this registration, the binding cache will look like the one shown by BC 384. It is important to understand that the registration at MAP 340 is not as in standard HMIPv6. Here the local BU needs to have some RO parameter so that the LCoAs of upstream MRs required to reach a RCoA can be obtained. The MAP 340 will send its response to VMN 310. This ACK message is shown by 385. This will be sent to LCoA of VMN 310. Thus this message will reach home agent of MR 320. There it will be tunneled as message 386 to the LCoA of MR 320 via MR 321. This message 386 will finally get decapsulated at MR 320 and the BA message 387 from MAP 340 will reach VMN 310. When MR 320 decapsulates the message 386, it will know that the message is coming from its home agent and thus it does not have registration at the source address of the packet. MR 320 will further check that the source address of the decapsulated packet is the MAP address. If it is the MAP address, then, MR 320 will process the MAP option (the next time it receives the RA or use a stored MAP option value) and register at the MAP 340. This registration is shown by 388 and 389 in the FIG. 3. MR 320 will perform a local BU at MAP 340 incorporating some RO parameter. The binding cache at MAP 340 after this registration is given by BC 390.

After this, VMN 310 will bind its HoA to its RCoA at CN 360 using the MIPv6 method. It is important to understand that at this instant, VMN 310 may have processed the ARO option but it may be using it for RO for some other flows. Before performing such HoA to RCoA binding registration at CN 360 using MIPv6 method, VMN 310 needs to register with its home agent HA 352. This registration is not explicitly shown in FIG. 3. VMN 310 can use RCoA when registering with its HA 352. Or if it has processed ARO option previously, then it may have used LCoA to carry out ARO registration at HA 352. These are not explicitly shown in FIG. 3. Nevertheless, irrespective of the registration type (RCoA based MIPv6 registration or LCoA based ARO registration) at the HA 352, VMN 310 can use RCoA and perform HoA to RCoA binding at CN 360 using the MIPv6 method.

The HoA to RCoA binding registration at CN 360 using MIPv6 method is shown by message 391. After such registration, the BC at CN 360 is shown by 392. Next, VMN 310 sends data packet to CN 360. Since VMN 310 has carried out HoA to RCoA binding registration at CN 360 using MIPv6 method, VMN 310 will tunnel the packet via the MAP 340. If VMN 310 has performed ARO type of local registration at MAP 340, then it will incorporate the NEMO-FWD option in the external tunnel header. This tunneled data to CN 360 is shown by 393. This message 393 will be decapsulated at MAP 340 and the inner message 394 will be sent to CN 360. When CN 360 sends data packet to VMN 310, it will send the packet to RCoA of VMN 310. This message 395 will be intercepted by MAP 340. MAP will use BC 390 to find all the LCoAs required to reach RCoA of VMN 310 and encapsulate the packet in a tunnel with all the LCoAs appearing in the destination address as well as the RH2. This encapsulated message 396 will finally reach VMN 310. At MAP 340, if the RO parameter shown in BC 390 is an ARO parameter, then tracing mechanisms at MAP 340 looks for match between the RO parameter associated with the VMN 310 RCoA and the RCoA column entries of BC 390. If the RO parameter associated with the RCoA of VMN 310 is a prefix, then the match is searched between this prefix and a prefix in the LCoA column entries of the BC 390. This above said RO tracing mechanism at MAP 340 obtains MR 321 LCoA, MR 320 LCoA and VMN 310 LCoA after a single loop of tracing.

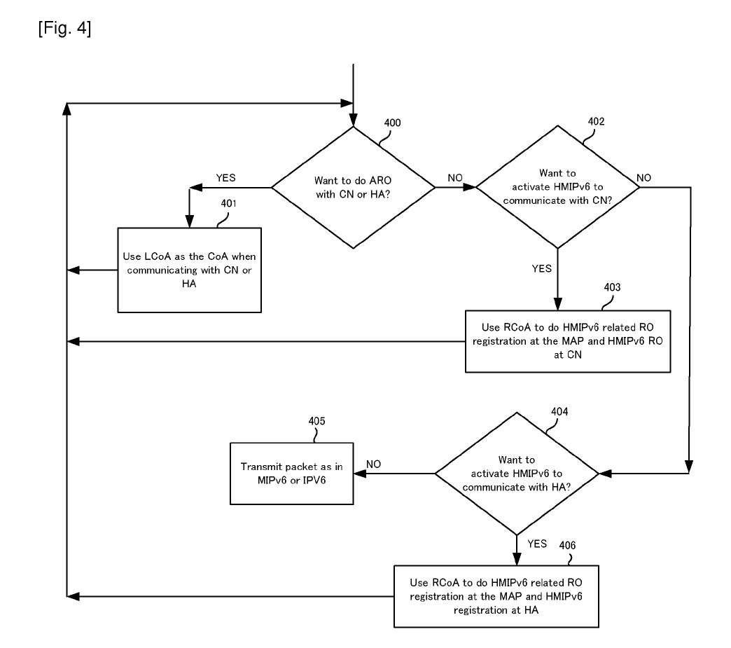

To further understand the methods given in the previous embodiments, in this embodiment, the operation of VMN implementing the methods discussed previously is given. In layer three of VMN protocol stack, it is assumed that there will be Internet Protocol version 6 (IPv6) routing module, MIPv6 routing module, ARO routing module which is derived from MIPv6 and also HMIPv6 routing module which is again derived from MIPv6. This above-mentioned HMIPv6 module will have more features than in normal HMIPv6 module. The above-mentioned additional feature may preferably be a method to perform local BU at MAP with some RO parameter that is associated with the type of MAP. It is further considered that VMN has a new processing module at layer three incorporating the functions outlined in FIGS. 2 and 3. This above said processing module will activate different routing modules such as ARO, HMIPv6, Standard IPv6 and so on depending on its state. This above said new processing module is further described by FIG. 4. Such processing as outlined by a flowchart in FIG. 4 is instantiated at some regular intervals so that VMN can choose appropriate routing protocols to communicate with its CNs, HAs or MAP.

In FIG. 4, the first step associated with the new processing module in VMN is step 400 which checks whether VMN wants to perform ARO with its CN or with its one or many home agents. The decision to perform ARO is purely up to VMN. It may want to do it for better RO for its flows. If VMN decides to do it, then step 401 is triggered. Step 401 gives a method where VMN will use its LCoA as its CoA to perform ARO binding with its CN or with its one or more home agents. If when evaluating step 400, VMN decides not to perform ARO, then step 402 is triggered. This step queries whether VMN wants to perform HoA to RCoA binding registration at CN using the MIPv6 method. If step 402 evaluates to yes then, step 403 is processed. Step 403 outlines the method where VMN will use RCoA and perform RO registration at MAP and also carry out HoA to RCoA binding registration at CN using the MIPv6 method. In order to do this step 403, the control of processing will be switched to the previously mentioned HMIPv6 stack. If step 402 evaluates to no, then the processing goes to step 404. At step 404 it is checked whether the VMN wants to carry out registration using the RCoA at one or more HAs and wants to carry out a RO based HMIPv6 registration at MAP. If 404 evaluate to yes then the processing module 406 is activated. This module performs the functionality where VMN use RCoA and perform HMIPv6 related RO registration at MAP and MIPv6 registration at one or more of its HAs. Nevertheless, if 404 evaluates to no, then the processing is passed to module MIPv6 or IPv6 module as given by step 405.

It is important to understand that when step 401 is performed the control is passed to the ARO stack, when steps 403 and 406 are performed, the control is passed to HMIPv6 stack which has some supporting codes to perform RO based registration at MAP and when step 405 is performed the control goes to IPv6 or MIPv6.

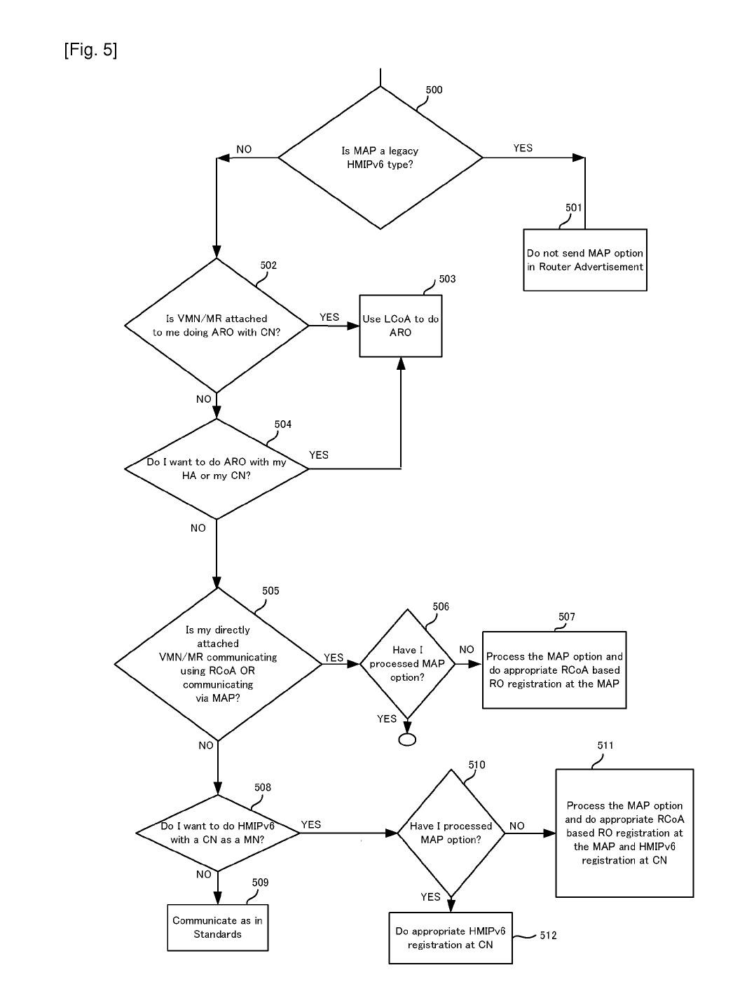

In another preferred embodiment of the present invention the operation of MR is described. This is further illustrated by the flow chart in FIG. 5. This embodiment explains the MR operation in a RO enabled MAP scenario as well as in a legacy MAP scenario. In this embodiment, in addition to the methods disclosed via FIGS. 2 and 3, the third method of the invention where MR makes appropriate decision to enable VMN/MR to perform RO with single or plurality of CNs or HAs in a legacy MAP scenario is outlined. The above said third method is such that, when the MR knows that the MAP is a legacy type of MAP with no RO functionality, it will not send the MAP option in its RA.

Layer three of the protocol architecture of MR will consist of ARO routing module, HMIPv6 routing module, NEMO basic routing module, IPv6 routing module, MIPv6 routing module and a new processing module. The above said HMIPv6 routing module will be a little different from standard HMIPv6 routing module. The difference mainly is that the local BU at MAP will have some RO parameter attached. Moreover, the MR will broadcast the MAP option in its RA in a RO enabled MAP scenario, which does not happen in normal HMIPv6 operation. It is further assumed that the RO registration at the MAP is in line with the RO type of the MAP. Basically, it is assumed that HMIPv6 routing module can do different type of ROs with MAP depending on the type of RO scheme of MAP.

The steps involved in the above said new processing module is next illustrated with reference to FIG. 5. Initially, step 500 will be executed to determine whether the MAP is legacy and if not, what type of RO scheme the MAP has (ARO enabled type, prefix delegation type, etc). There are various ways this can be determined, such as by means of new type of MAP option attached in RA received or by means of new option that is attached to the RA received or by means of some test signal originating from MR to the MAP. For example, if MR receives a new MAP option or a new option attached to RA, which informs the type of MAP (legacy, type of RO in MAP), then MR would know the type of MAP and act accordingly. The advantage of this method is that MR need not do explicit signaling and waste its power. Nevertheless, the problem with this method is that, the fixed routers need to understand these special options and retransmit them in their RAs. This requires considerable changes to the system and induces scalability issues. If MR was to test the type of MAP by external signaling then it could perhaps use an ARO type of BU test to MAP or a prefix delegation request test to MAP. This would inject more signaling into the system because of bi-directional request and response signaling. It can be easily understood that response from MAP occurs only if the MAP understands the type of signaling. For example, when ARO type of BU is performed at legacy MAP, then, no response is sent from the MAP. Moreover, in this second method where explicit test signaling takes place, the power of MR will be wasted as well. Moreover, different types of test signaling may need to take place to know the exact type of MAP, which can further increase signaling load and further waste MR power. The advantage of this second method is that no change required to fixed routers. If ARO type BU test is performed, then the ARO option can have MR's care-of address if no ARO option is received. Such an address is used because, when MR becomes a top-level mobile router, no ARO option is received. It is important to understand, in addition to knowing whether the MAP is legacy or not, it is also important to know the type of RO scheme the MAP is using so that MR can do appropriate RO related local registration at the MAP.

If step 500 evaluates to yes, then to eliminate the anomalies of the prior art as discussed previously, step 501 is executed. This step involves a decision made by the MR, such that it stops advertising the MAP option in its RA since MR knows the MAP is legacy type. MR makes such decision in a legacy MAP scenario because; MAP does not have a RO tracing mechanism incorporated and it is completely not useful to provide services for a nested NEMO ARO and HMIPv6 scenario. Thus, the MAP cannot be used for RO unless the MN (VMN/MR) is not nested. After completing the step 501, the control can go to 502 or the MR can operate as in standard ARO and HMIPv6 operation without going through steps 502-512. This is the reason why an explicit step after 501 is not shown in FIG. 5. More will be described of this in another forthcoming embodiment.

If step 500 evaluates to no, then step 502 is executed. This step incorporates a decision process where it is checked whether VMN/MR directly attached to this MR is using ARO to communicate with its own CN. If 502 evaluate to yes, then irrespective of the type of options processed by MR, step 503 is executed. Step 503 involves a procedure where MR will use its LCoA and establish ARO with the CN of the VMN/MR directly attached to it. If 502 evaluates to no then a further test as shown by step 504 is conducted. This determines whether MR wants to perform ARO with one or more of its HAs or CNs. If step 504 evaluates to yes then, again, step 503 is executed. If step 504 evaluates to no, then step 505 is executed. In this step it is checked whether the VMN/MR directly attached to this MR is communicating with the MAP. If step 505 evaluates to yes then, step 506 is executed. This checks whether MR has already processed the MAP option. If step 506 evaluates to no then step 507 is executed. Step 507 has a procedure where the MAP option is processed and MR does appropriate RO based registration at MAP. No action is taken if step 506 evaluates to yes. If step 505 evaluates to no, then step 508 is executed. Here it is tested whether MR wants to perform HoA to RCoA binding registration at its own CN using MIPv6 method, as a MN. If step 508 evaluates to yes then step 510 is executed. In step 510 it is checked whether the MAP option is processed or not. If step 510 evaluates to no then step 511 is processed. Step 511 associates a procedure where the MR will process the MAP option and carry out appropriate RO registration at the MAP and HoA to RCoA binding registration at one or more CNs using the MIPv6 method. If step 510 evaluates to yes then step 512 is carried. Step 512 has a procedure where the MR will establish appropriate HoA to RCoA binding registration at one or more of its CNs using the MIPv6 method. If step 508 evaluates to no then step 509 is carried out where standard NEMO basic, MIPv6 or IPv6 operations is used.

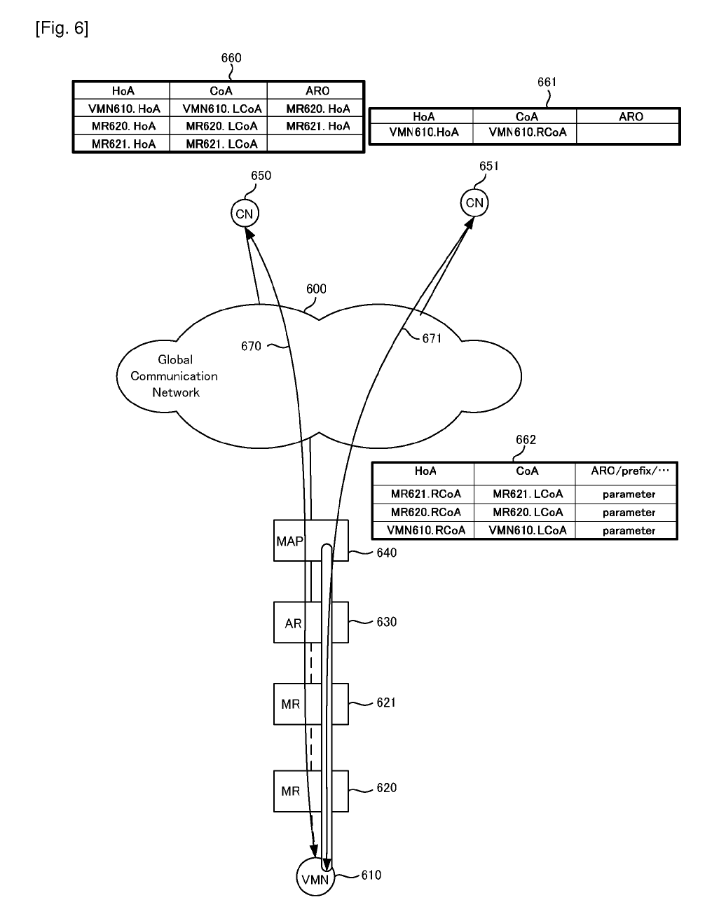

In yet another preferred embodiment of the present invention, to fully understand the effect of the main invention in a RO enabled MAP scenario where the VMNs/MRs can process ARO, MAP or ARO+MAP options, the final data path between VMN and CN is described. The above said solution effect is described by the network diagram shown in FIG. 6.

In FIG. 6, VMN 610 is attached to MR 620, MR 620 is attached to MR 621, MR 621 is attached to AR 630, AR 630 is attached to MAP 640 and MAP 640 is attached to the global communications network 600. It is further assumed that VMN 610 is communicating with two CNs, CN 650 and CN 651, at the same time. It is further assumed that the binding cache at MAP 640 is shown by BC 662, the binding cache at CN 650 is shown by BC 660 and the binding cache at CN 651 is shown by BC 661 in FIG. 6. It is also assumed that, VMN 610 decides to perform ARO type of RO with CN 650 and also it decides to perform HoA to RCoA binding registration at CN 651 using the MIPv6 method. By using the methods associated with this invention, irrespective of the options VMN 610 process, if it decides to perform ARO with CN 650 then it will use LCoA to establish ARO. Moreover, MR 620 and MR 621 will also use LCoA to establish ARO with CN 650. Thus, as can be seen from the FIG. 6, BC 660 has all the required LCoAs required to reach VMN 610 optimally. Moreover, the solution eliminates the heterogeneous address problem associated with the binding cache as disclosed in the prior art. The route-optimized path when VMN 610 performs ARO with CN 650 is shown by 670 in FIG. 6. It can be seen that the path is fully optimized without any tunneling involved.

When VMN 610 decides to use RCoA and establish location management based RO with CN 651, then VMN 610 will use RCoA and perform appropriate RO based local BU registration at MAP 640 and also carry out HoA to RCoA based binding registration at CN 651 using the MIPv6 method. The HoA to RCoA binding registration at CN 651 using the MIPv6 method is shown by BC 661. The third row in BC 662 shows the entry made by VMN 610. Again, using the method of the invention, MR 621 and MR 620, irrespective of the options they have processed, will perform appropriate RO registration at the MAP 640. It can be understood to one skilled in the art that the BC 662 has all required parameters to trace the RCoA of VMN 610 correctly. Thus, VMN 610 and CN 651 can engage in location management efficiency based RO with each other. This message is shown by 671. The data packet from VMN 610 to CN 651 will be encapsulated in a tunnel from VMN 610 to the MAP 640. The mobile routers MR 620 and MR 621 will simply change the source address to their LCoAs when routing the packet via path 671 when the packet is sent in the reverse direction. In the forward direction, the packet from CN 651 will be intercepted by MAP 640 and encapsulated in a tunnel. MAP 640 will look for entries to reach the RCoA of VMN 610. One can see that all the entries are there in BC 662 to reach the RCoA of VMN 610. The RO mechanism at MAP 640 can be any type (such as ARO, prefix delegation with PSBU, PSBU with validation, etc).

From this solution effect shown in FIG. 6, one can clearly see that the VMN 610 can select the type of RO scheme it wants to provide for its flows or applications and then choose the appropriate CoA for the RO scheme selected. It is also important to understand that, when VMN 610 is performing ARO with CN 650, it could use HoA to RCoA binding registration at it's HA using the MIPv6 method. Furthermore, when VMN 610 is using HoA to RCoA binding registration at CN 651 using the MIPv6 method, it could possibly carry out ARO type registration with its HA.

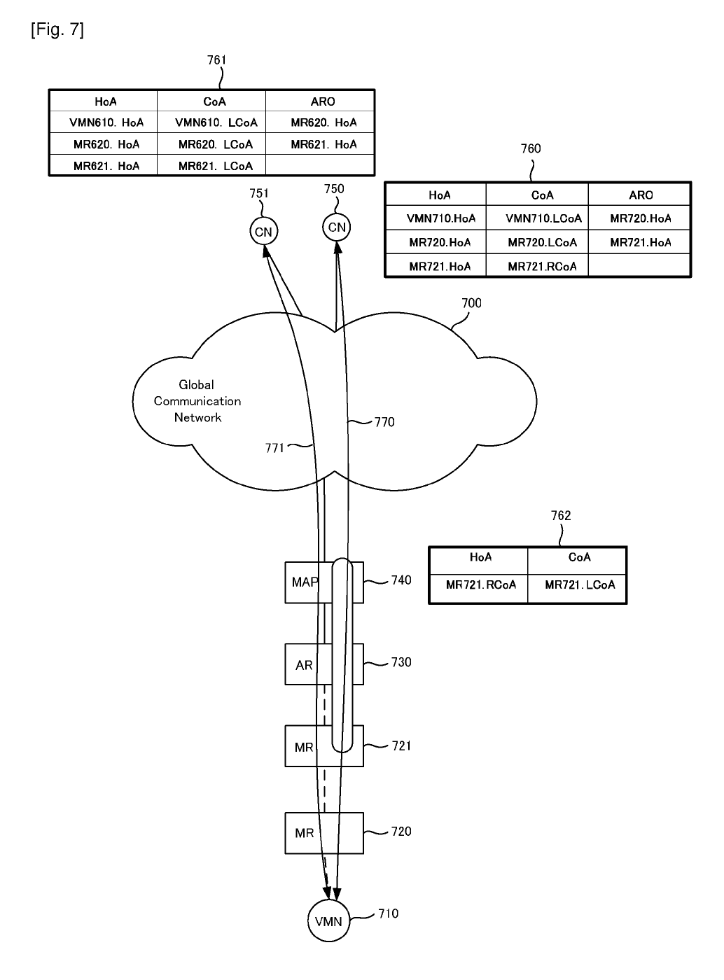

In yet another preferred embodiment of the present invention, to fully understand the effect of the main invention in a legacy MAP scenario, the final data path between VMN and CN is described. The above said solution effect is described by the network diagram shown in FIG. 7.

In FIG. 7, VMN 710 is attached to MR 720, MR 720 is attached to MR 721, MR 721 is attached to AR 730, AR 730 is attached to MAP 740 and MAP 740 is attached to the global communications network 700. It is further assumed that VMN 710 is communicating with two CNs at the same time. The above-mentioned correspondent nodes are CN 750 and CN 751 respectively. It is further assumed that the binding caches at MAP 740, CN 750, and CN 751 are shown by BC 762, BC 760 and BC 761 respectively in FIG. 7.

In this system, it is assumed that MR 721 has identified that MAP 740 is a HMIPv6 legacy type of MAP and thus MR 721 does not advertise the MAP option in its RA. Thus, VMN 710 and MR 720 only have the ARO option and are not aware of the MAP's presence in their network. In such an environment, VMN 710 will process only the ARO option when it communicates with its CNs.

Initially, the data communication between VMN 710 and CN 750 is looked at in detail. VMN 710 performs ARO with CN 750. Similarly MR 720 will perform ARO with CN 750 when it gets appropriate ACK from CN 750 or when MR 720 encounters NEMO-FWD option. Since MR 720 only has the ARO option to process, the new processing unit outlined in the previous embodiment and explained in FIG. 5 will not be executed. When MR 721 establishes ARO with CN 750, it can merely use the RCoA and establish ARO. It was explained in a previous embodiment that when MR stops sending the MAP option in its RA, the MR can use standard mechanism or decide to use the new processing unit outlined in FIG. 5. In this particular instance, it is assumed that MR 721 does not process the new processing unit outlined in FIG. 5 but instead, use standard ARO and HMIP protocols. This is shown by the path 770. The entries in BC 760 are the entries of CN 750. It can be seen that VMN 710 HoA can be reached by reaching MR 721 RCoA, MR 720 LCoA and VMN 710 LCoA. If CN 750 sends a data packet to VMN 710, then the destination address will be set to MR 721 RCoA and the RH will have MR 720 LCoA, VMN 710 LCoA and VMN 710 HoA. If such a packet is constructed at CN 750, then the data path will be as shown by 770. There will be a single tunnel from MAP 740 to MR 721. The path 770 is a route-optimized path with a single tunnel. Nevertheless, the advantage of this path is that that ARO type of recursive signaling originating from MR 721 will be less because, the RCoA is that what is given to CN 750 and it will not change often as LCoA.

Next the data communication path 771 between VMN 710 and CN 751 is looked into. Again, it can be seen that VMN 710 and MR 720 only have the ARO option to process. Thus, when VMN 710 starts ARO binding with CN 751, the registration from VMN 710 and MR 721 will be pure ARO type. In such a case, MR 721 can either process the new processing module given by FIG. 5 or use its normal mechanism. In data path 771 it is assumed that MR 721 will use the new processing algorithm and use the LCoA when performing ARO with CN 751. Thus, the binding cache at CN 751 is given by BC 761, which shows all LCoA entries. From BC 761 it can be seen that, the pure ARO effect is achieved when VMN 710 and CN 751 are communicating with each other. The path 771 will have no tunneling. In that aspect, it has a better advantage than the path 770. Nevertheless, in this case, the ARO signaling will be slightly higher. This is because, all LCoA registrations are at BC 761 and in a high mobility environment, the LCoAs will be subjected to frequent changes and hence more ARO registrations at CN 751 during a given time.

Although the invention has been herein shown and described in what is conceived to be the most practical and preferred embodiment, it will be appreciated by those skilled in the art that various modifications may be made in details of design and parameters without departing from the scope and ambit of the invention. For instance, the present invention uses ARO scheme as the route optimization mechanism used in nested mobile networks. It should be appreciated by a person skilled in the art that the present invention could be applied to other route optimization mechanism as well, such as one that uses mobile router's address in some way to achieve route optimization. In addition, the present invention uses HMIPv6 as the local mobility management protocol. It should be appreciated by a person skilled in the art that the present invention could be applied to other local mobility management protocols as well.

### INDUSTRIAL APPLICABILITY

The present invention has the advantage of providing a useful mechanism in an ARO and HMIPv6 heterogeneous environment, and can be applied to the field of packet-switched communication.

1. A system of communications node comprising VMNs, MRs, MAPs, HAs and CNs wherein the VMNs and MRs have an ARO and HMIPv6 protocol implemented, wherein there is a single MAP in a domain architecture, which has some RO functionality implemented and the HAs have an ARO protocol implemented, and wherein, if a first arbitrary node wants to carry out ARO with a second arbitrary node irrespective of options that has been processed by the first arbitrary node, it uses its LCoA as its care-of address.

2. The system according to claim 1 wherein the said first arbitrary node is a VMN and it uses its LCoA as its CoA to perform ARO with one or more of its CNs.

3. The system according to claim 1 wherein the said first arbitrary node is a MR and it uses its LCoA as its care-of address to perform ARO with VMN's or other MR's CNs.

4. The system according to claim 1 wherein the said first arbitrary node is a VMN and it uses its LCoA as its CoA to perform ARO with its one or more HAs.

5. The system according to claim 1 wherein the said first arbitrary node is a MR and it uses its LCoA as its CoA to perform ARO with its one or more HAs.

6. The system according to claim 1 wherein the said first arbitrary node is a MR and it uses its LCoA as its CoA to perform ARO with its one or more CNs.

7. A system of communications node comprising VMNs, MRs, MAPs, HAs and CNs wherein the VMNs and MRs have an ARO and HMIPv6 protocol implemented, wherein there is a single MAP in a domain architecture, which has some RO functionality implemented and the HAs have an ARO protocol implemented, and wherein a first arbitrary node wants to perform HMIPv6 with a second arbitrary node, irrespective of options being processed by the first arbitrary node, it uses its RCoA as its care-of address.

8. The system according to claim 7 wherein the said first arbitrary node is a VMN and it uses its RCoA to perform HMIPv6 with one or more of its CNs.

9. The system according to claim 7 wherein the said first arbitrary node is a VMN and it uses its RCoA to perform HMIPv6 with its one or more HAs.

10. The system according to claim 7 wherein the said first arbitrary node is a MR and it uses its RCoA to perform HMIPv6 with one or more of its CNs.

11. The system according to claim 7 wherein the said first arbitrary node is a MR and it uses its RCoA to perform HMIPv6 with its one or more HAs.

12. The system according to claim 7 wherein the said first arbitrary node is a VMN and it performs RO based local registration at MAP where it uses its RCoA as its local home address and its LCoA as its care-of address.

13. The system according to claim 7 wherein the said first arbitrary node is a MR and it performs RO based local registration at MAP where it uses its RCoA as its local home address and its LCoA as its care-of address.

14. A method used in the system defined in claim 7 wherein if a MR has not processed a MAP option, it will process the MAP option, derive a RCoA and make RO based local registration at the MAP, if its directly attached VMNs or MRs have already done RO based local registration at that MAP.

15. The method according to claim 14, wherein the RCoA is registered as the home address with some RO parameter at the MAP, so that a LCoAs required reaching the above mentioned RCoA can be done in a very optimized manner.

16. A system of communications node comprising VMNs, MRs, MAPs, HAs and CNs wherein the VMNs and MRs have an ARO and HMIPv6 protocol implemented, wherein there is a single MAP in a domain architecture and this MAP is a legacy HMIPv6 type and the HAs have an ARO protocol implemented, and wherein the MR makes a decision such that, when it knows that the MAP is legacy type, does not send a MAP option in its RA.

17. The system according to claim 16 wherein the MR relies on a new MAP option attached to the RA to know a type of MAP.

18. The system according to claim 17 wherein information on the type of MAP can be a type of RO scheme associated with the MAP or information on the legacy MAP.

19. The system according to claim 16 wherein the MR relies on a new option attached to RA to know the type of MAP.

20. The system according to claim 19 wherein information on the type of MAP could be the type of RO scheme associated with the MAP or information on the legacy MAP.

21. The system according to claim 16 wherein the MR relies on some explicit signaling to know a type of MAP.

22. The system according to claim 21 wherein the said explicit signaling can be ARO type of BU performed at the MAP, where the address in an ARO option could be MR's local care-of address.

23. The system according to claim 21 wherein the said explicit signaling can be the prefix delegation request type of message.

24. The system according to claim 16 wherein the MR, which makes the decision of not sending the MAP option, could use its LCoA to carry out ARO with its directly attached VMN's or MR's HAs or CNs.

25. The system according to claim 16 wherein the MR, which makes the decision of not sending the MAP option, could use its RCoA to perform ARO with its directly attached VMN's or MR's HAs or CNs.

26. An apparatus associated with VMN in the system defined in claim 1.

27. An apparatus associated with VMN in the system defined in claim 7.

28. An apparatus associated with VMN in the system defined in claim 16.

29. An apparatus associated with MR in the system defined in claim 1.

30. An apparatus associated with MR in the system defined in claim 7.

31. An apparatus associated with MR in the system defined in claim 16.
